(19) United States
(12) Patent Application Publication
(10) Pub. No.: US 2016/0365044 A1
(43) Pub. Date: Dec. 15, 2016

(54) DISPLAY DEVICE AND DRIVING METHOD THEREOF

(71) Applicant: Au Optronics Corporation, Hsinchu (TW)

(72) Inventor: Hui Chu Ke, Hsinchu City (TW)

(21) Appl. No.: 15/012,877

(22) Filed: Feb. 2, 2016

(30) Foreign Application Priority Data
Jun. 9, 2015 (TW) 104118628

(51) Int. Cl. G09G 3/36

(52) U.S. Cl. CPC G09G 3/3607; G09G 2320/0233; G09G 2320/0666; G09G 2340/0457

(57) ABSTRACT

A display device is provided. The display device includes a display panel, an image signal input unit, and a sub-pixel rendering (SPR) unit. The display panel includes a plurality of repeating units. Each repeating unit includes two first sub-units and two second sub-units. Each first sub-unit includes eight sub-pixels including two first color sub-pixels, two second color sub-pixels, two third color sub-pixels and two white sub-pixels, and each second sub-unit includes eight sub-pixels including two first color sub-pixels, four second color sub-pixels and two third color sub-pixels. The image signal input unit serves to receive image signals. The sub-pixel rendering unit is used for performing a sub-pixel rendering process to the image signals, so that the sub-pixels of the display panel produce performance values.

### CROSS-REFERENCE TO RELATED APPLICATION

This application claims the priority benefit of Taiwan application serial no. 104118628, filed on Jun. 9, 2015. The entirety of the above-mentioned patent application is hereby incorporated by reference herein and made a part of this specification.

### BACKGROUND OF THE INVENTION

Field of the Invention

The invention relates to a display device, and particularly relates to a display device having good transmittance and brightness and a driving method of the display device.

Description of Related Art

A head-up display is a flight assistance device generally used in aircrafts, and a part of current vehicles is also configured with the head-up display for projecting vehicle status such as a vehicle speed, a rotation rate, an engine temperature, fuel consumption, etc. to a windshield for a driver to view.

Generally, an image displayed by the head-up display is relatively simple, and the image is produced in a distance that is not suitable for human eyes to finely recognize, so that compared with the other display devices used for display images such as mobile phones, tablet personal computers (PCs), etc., the head-up display has a lower requirement on image resolution. However, in order to ensure the driver to easily view the image projected on the windshield under a clear sky, the head-up display has a higher demand on brightness compared with that of the other display devices. Therefore, how to effectively improve a transmittance and a brightness of a display panel in the head-up display is an important subject positively researched by related technicians of the field.

### SUMMARY OF THE INVENTION

The invention is directed to a display device, which has a good pixel aperture ratio, transmittance and brightness.

The invention is directed to a driving method of a display device, by which a display panel simultaneously have a good pure-color and none pure-color brightness display effect.

The invention provides a display device including a display panel, an image signal input unit, and a sub-pixel rendering unit. The display panel includes a plurality of repeating units. Each of the repeating units includes two first sub-units and two second sub-units. Each of the first sub-units includes eight sub-pixels, and the eight sub-pixels include two first color sub-pixels, two second color sub-pixels, two third color sub-pixels and two white sub-pixels. Each of the second sub-units includes eight sub-pixels, and the eight sub-pixels include two first color sub-pixels, four second color sub-pixels and two third color sub-pixels. The image signal input unit is configured to receive an image signal. The sub-pixel rendering unit is is configured to perform a sub-pixel rendering process to the image signal, so that the sub-pixels of the display panel produce a performance value.

The invention provides a driving method of a display device, which includes following steps. First, the display device is provided. Then, the image signal is input to the image signal input unit. Then, a sampling position analysis step is performed. Thereafter, the sub-pixel rendering unit performs a sub-pixel rendering processing step of a first sub-unit and a sub-pixel rendering processing step of a second sub-pixel. Then, an mixing arrangement of image data processing step is performed. Finally, a processed image signal is output, such that the display device displays an image.

According to the above descriptions, in the display device of the invention, each of the repeating units in the display panel includes two first sub-units and two second sub-units, wherein each of the first sub-units includes two first color sub-pixels, two second color sub-pixels, two third color sub-pixels and two white sub-pixels, and each of the second sub-units includes two first color sub-pixels, four second color sub-pixels and two third color sub-pixels. The display panel is used in collaboration with the image signal input unit and the sub-pixel rendering unit to perform the sub-pixel rendering process. In this way, compared with the conventional display device, the display device of the invention has a good pixel aperture ratio, transmittance, pure-color and none pure-color brightness and image visual resolution, so as to provide good image quality.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic block view of a display device according to an embodiment of the invention.

FIG. 2 is a schematic top view of a first embodiment of a repeating unit of the invention.

FIG. 3 is a schematic cross-sectional view of one embodiment of a display panel along a section line I-I′ of FIG. 2.

FIG. 4 is a schematic cross-sectional view of another embodiment of the display panel along the section line I-I′ of FIG. 2.

FIG. 5 is a flowchart illustrating a driving method of a display device according to an embodiment of the invention.

FIG. 6A-FIG. 6D are respectively schematic views of defining a sampling range of a display panel of the display device of FIG. 1.

FIG. 7 is a schematic top view of a second embodiment of a repeating unit of the invention.

FIG. 8 is a schematic top view of a third embodiment of a repeating unit of the invention.

FIG. 9 is a schematic view of a head-up display according to an embodiment of the invention.

### DESCRIPTION OF EMBODIMENTS

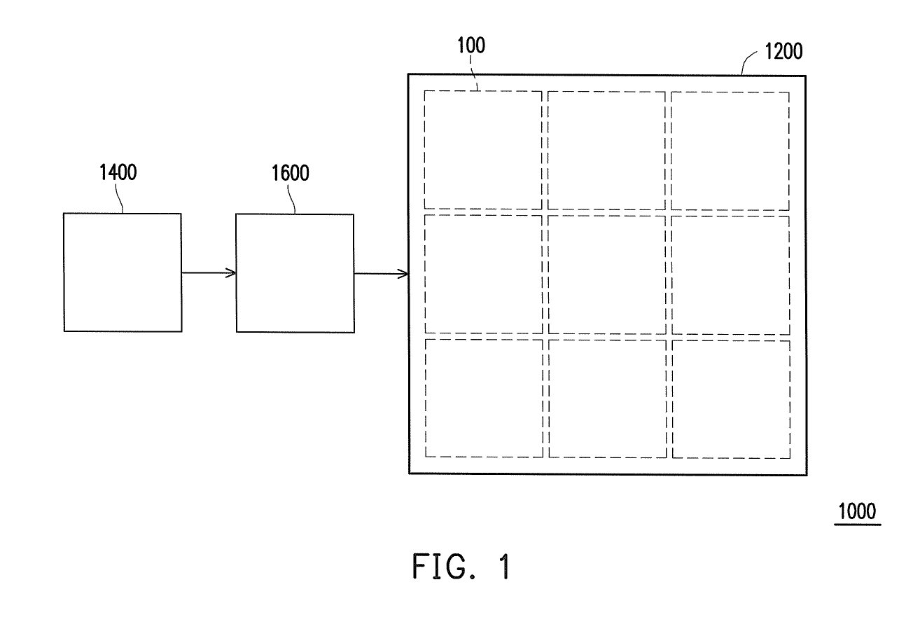

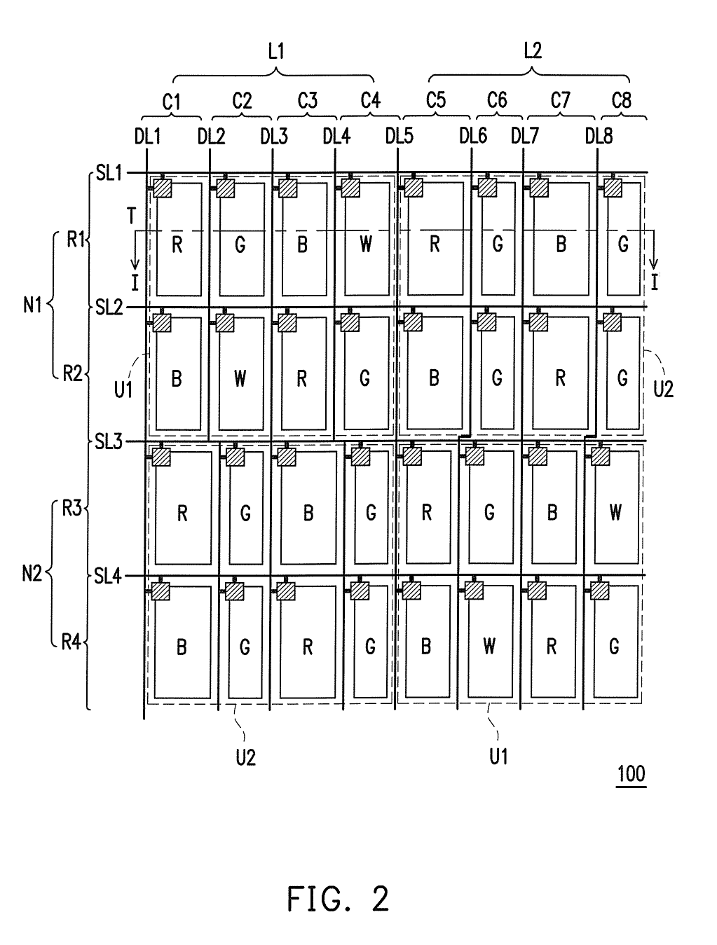

FIG. 1 is a schematic block view of a display device according to an embodiment of the invention. FIG. 2 is a schematic top view of a first embodiment of a repeating unit of the invention.

Referring to FIG. 1, a display device 1000 includes a display panel 1200, an image signal input unit 1400 and a sub-pixel rendering unit 1600.

Referring to FIG. 1 and FIG. 2, the display panel 1200 includes a plurality of repeating units 100 arranged in an array. Although 9 repeating units 100 are illustrated in FIG. 1, the invention is not limited thereto. In other embodiment, the number of columns and rows (i.e. the number of the repeating units 100) of the array can be adjusted by those skilled in the art according to an actual design requirement. Moreover, for simplicity's sake, only one repeating unit 100 is illustrated in FIG. 2.

Referring to FIG. 2, each of the repeating units 100 includes 2 first sub-units U1 and 2 second sub-units U2 arranged in an array of two rows N1-N2 and two columns L1-L2. In detail, the row N1 and the row N2 respectively include one first sub-unit U1 and one second sub-unit U2, and the arrangement of the first sub-unit U1 and the second sub-unit U2 on the row N1 is different to the arrangement of the first sub-unit U1 and the second sub-unit U2 on the row N2.

Moreover, each of the first sub-units U1 includes eight sub-pixels arranged in an array of two rows and four columns (2×4), which are two first color sub-pixels R, two second color sub-pixels G, two third color sub-pixels B and two white sub-pixels W, and each of the second sub-units U2 includes eight sub-pixels arranged in an array of two rows and four columns (2×4), which are two first color sub-pixels R, four second color sub-pixels G and two third color sub-pixels B. Namely, in the present embodiment, each of the repeating units 100 includes thirty-two sub-pixels arranged in eightcolumns C1-C8 and four rows R1-R4.

In detail, the first sub-unit U1 on the row N1 and the column L1 includes eight sub-pixels arranged on the columns C1-C4 and the rows R1-R2; the first sub-unit U1 on the row N2 and the column L2 includes eight sub-pixels arranged on the columns C5-C8 and the rows R3-R4; the second sub-unit U2 on the row N1 and the column L2 includes eight sub-pixels arranged on the columns C5-C8 and the rows R1-R2; and the second sub-unit U2 on the row N2 and the column L1 includes eight sub-pixels arranged on the columns C1-C4 and the rows R3-R4.

In detail, the first row (i.e. the row R1) of the first sub-unit U1 on the row N1 and the column L1 and the first row (i.e. the row R3) of the first sub-unit U1 on the row N2 and the column L2 respectively include, from left to right, the first color sub-pixel R, the second color sub-pixel G, the third color sub-pixel B and the white sub-pixel W; and the second row (i.e. the row R2) of the first sub-unit U1 on the row N1 and the column L1 and the second row (i.e. the row R4) of the first sub-unit U1 on the row N2 and the column L2 respectively include, from left to right, the third color sub-pixel B, the white sub-pixel W, the first color sub-pixel R and the second color sub-pixel G. Namely, in the present embodiment, the first row and the second row of each of the first sub-units U1 respectively have one first color sub-pixel R, one second color sub-pixel G, one third color sub-pixel B and one white sub-pixel W, and the arrangement of the first color sub-pixel R, the second color sub-pixel G, the third color sub-pixel B and the white sub-pixel W of the first row is different to the arrangement of the first color sub-pixel R, the second color sub-pixel G, the third color sub-pixel B and the white sub-pixel W of the second row.

Moreover, the first row (i.e. the row R1) of the second sub-unit U2 on the row N1 and the column L2 and the first row (i.e. the row R3) of the second sub-unit U2 on the row N2 and the column L1 respectively include, from left to right, the first color sub-pixel R, the second color sub-pixel G, the third color sub-pixel B and the second sub-pixel G; and the second row (i.e. the row R2) of the second sub-unit U2 on the row N1 and the column L2 and the second row (i.e. the row R4) of the second sub-unit U2 on the row N2 and the column L1 respectively include, from left to right, the third color sub-pixel B, the second color sub-pixel G, the first color sub-pixel R and the second color sub-pixel G. Namely, in the present embodiment, the first row and the second row of each of the second sub-units U2 respectively have one first color sub-pixel R, two second color sub-pixel G, one third color sub-pixel B, and the arrangement of the aforementioned four sub-pixels of the first row is different to the arrangement of the aforementioned four sub-pixels of the second row.

According to the above design, in the repeating unit 100, the row R1 includes, from left to right, the first color sub-pixel R, the second color sub-pixel G, the third color sub-pixel B, the white sub-pixel W, the first color sub-pixel R, the second color sub-pixel G, the third color sub-pixel B and the second color sub-pixel G; the row R2 includes, from left to right, the third color sub-pixel B, the white sub-pixel W, the first color sub-pixel R, the second color sub-pixel G, the third color sub-pixel B, the second color sub-pixel G, the first color sub-pixel R and the second color sub-pixel G; the row R3 includes, from left to right, the first color sub-pixel R, the second color sub-pixel G, the third color sub-pixel B and the second color sub-pixel G, the first color sub-pixel R, the second color sub-pixel G, the third color sub-pixel B and the white sub-pixel W; and the row R4 includes, from left to right, the third color sub-pixel B, the second color sub-pixel G, the first color sub-pixel R, the second color sub-pixel G, the third color sub-pixel B, the white color sub-pixel W, the first color sub-pixel R and the second color sub-pixel G (arrangement 4).

On the other hand, in each of the first sub-units U1, areas of each of the first color sub-pixels R, each of the second color sub-pixels G, each of the third color sub-pixels B and each of the white sub-pixels W are the same, and in each of the second sub-units U2, an area of each of the second color sub-pixels G is 50% of an area of one first color sub-pixel R, and the area of each of the first color sub-pixels R is the same with an area of each of the third color sub-pixels B. Further, in the repeating unit 100, the area of each of the second color sub-pixels G in the second sub-unit U2: the area of each of the first color sub-pixels R, each of the second color sub-pixels G, each of the third color sub-pixels B or each of the white sub-pixels W in the first sub-unit U1: the area of each of the first color sub-pixels R or each of the third color sub-pixels B in the second sub-unit U2 is 1:1.5:2.

In this way, in case that each of the first sub-units U1 includes two first color sub-pixels R, two second color sub-pixels G, two third color sub-pixels B and two white sub-pixels W, and each of the second sub-units U2 does not include the white sub-pixel W and includes four second color sub-pixels G, in each of the repeating unit 100, the total area of the first color sub-pixels R, the total area of the second color sub-pixels G and the total area of the third color sub-pixels B are the same and are greater than the total area of the white sub-pixels W.

Moreover, compared with a red color and a blue color, human eyes are more sensitive to a green color, so that in each of the second sub-units U2, by designing the area of each of the first color sub-pixels R and the area of each of the third color sub-pixels B to be twice of the area of each of the second color sub-pixels G, the display panel 1200 can still provide good image quality.

Moreover, each of the first color sub-pixels R, each of the third color sub-pixels B, each of the second color sub-pixels G and each of the white sub-pixels W are respectively driven by a corresponding one of scan lines SL1-SL4, a corresponding one of data lines DL1-DL8 and one driving device T. For example, the first color sub-pixel R on the first row R1 and the first column C1 is driven by the scan line SL1 and the data line DL1, and the first color sub-pixel R on the second row R2 and the third column C3 is driven by the scan line SL2 and the data line DL3. The driving device T is electrically connected to the corresponding one of the scan lines SL1-SL4 and the corresponding one of the data lines DL1-DL8.

Moreover, the display panel 1200 is a component capable of display images, and the display panel 1200 can be a none self-luminous display panel including a liquid crystal display (LCD) panel, an electrophoretic display panel, an electrowetting display panel or a self-luminous display panel including an organic light-emitting diode (OLED) display panel, a plasma display panel or a field emission display panel. To be specific, in case that the display panel 1200 is an LCD panel, the driving device T is, for example, a thin film transistor (TFT), though the invention is not limited thereto. If the display panel 1200 is an OLED display panel, the driving device T, for example, includes two TFTs and one capacitor, though the invention is not limited thereto.

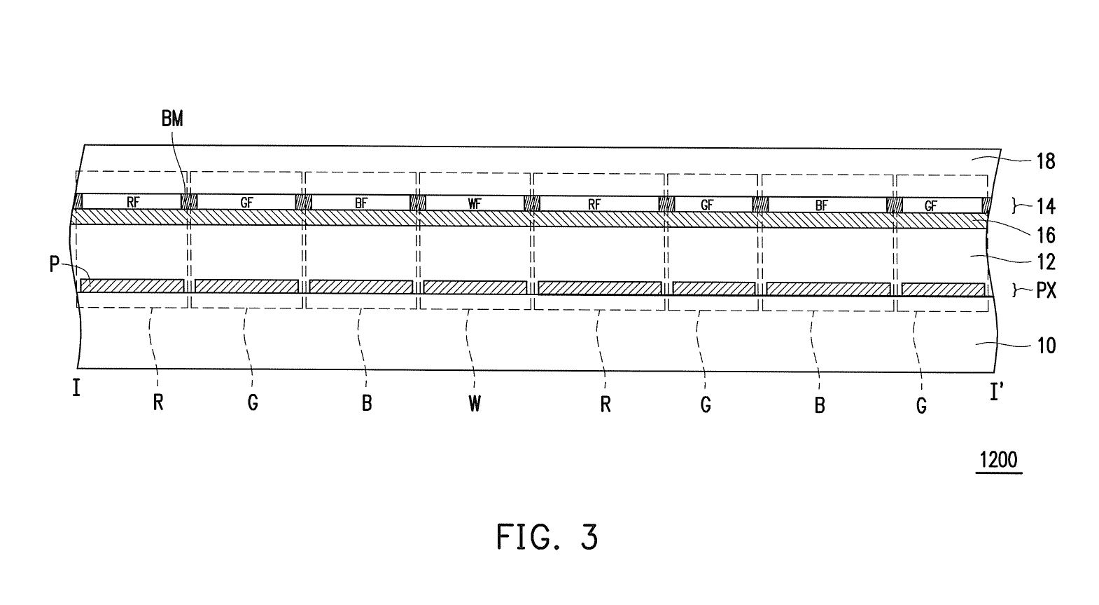

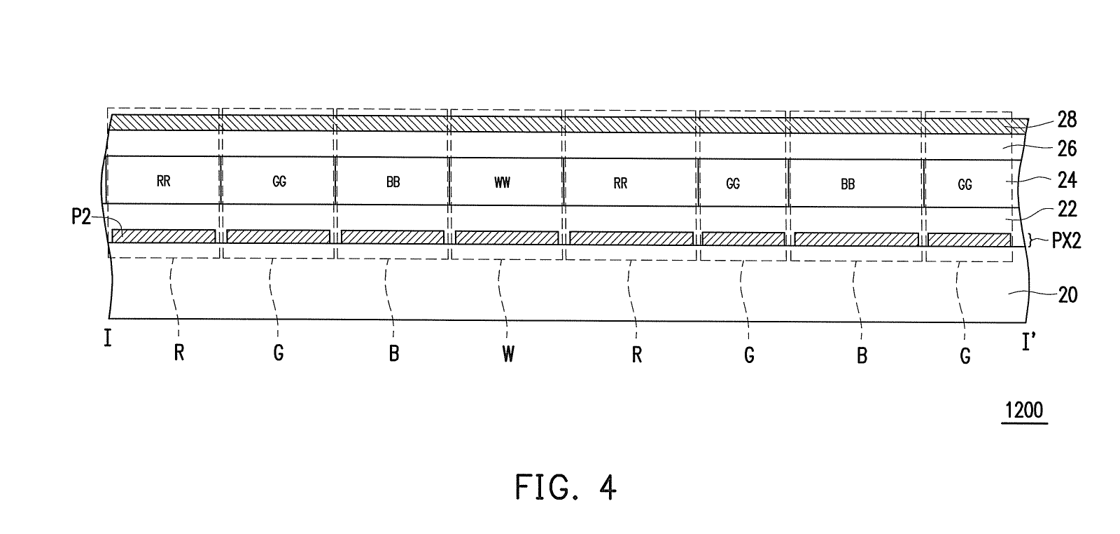

To be specific, a detailed structure of the display panel 1200 is introduced with reference of FIG. 3 and FIG. 4. FIG. 3 is a schematic cross-sectional view of one embodiment of the display panel along a section line I-P of FIG. 2. FIG. 4 is a schematic cross-sectional view of another embodiment of the display panel along the section line I-I′ of FIG. 2.

Referring to FIG. 3, the display panel 1200 includes a first substrate 10, a second substrate 18, a device layer PX, a liquid crystal layer 12 and a color filter layer 14. In detail, in the present embodiment, the display panel 1200 is an LCD panel.

A material of the first substrate 10 can be glass, quartz, organic polymer, or opaque or reflective material (for example, metal). The second substrate 18 is located opposite to the first substrate 10. A material of the second substrate 18 can be glass, quartz or organic polymer. The liquid crystal layer 12 is located between the first substrate 10 and the second substrate 18.

The color filter layer 14 is disposed on the second substrate 18. However, the invention is not limited thereto. In other embodiments, the color filter layer 14 can also be disposed on the first substrate 10. The color filter layer 14 includes a plurality of first color filter patterns RF, a plurality of second color filter patterns BF, a plurality of third color filter patterns GF and a plurality of white filter patterns WF. To be specific, in the present embodiment, the first color filter patterns RF, the second color filter patterns BF and the third color filter patterns GF are respectively red filter patterns, blue filter patterns and green filter patterns. However, the invention is not limited thereto. In other embodiments, the first color filter patterns RF, the second color filter patterns BF and the third color filter patterns GF can be an arbitrary combination of other color filter patterns. Moreover, the first color filter patterns RF, the second color filter patterns BF, the third color filter patterns GF and the white filter patterns WF can be respectively any filter pattern known by those skilled in the art.

Moreover, a black matrix BM can be further configured on the second substrate 18. The black matrix BM has a plurality of openings, and the first color filter patterns RF, the second color filter patterns BF, the third color filter patterns GF and the white filter patterns WF are respectively disposed in the openings.

In addition, an electrode layer 16 can be further configured on the second substrate 18. The electrode layer 16 is a transparent conductive layer, and a material thereof includes metal oxide, such as indium tin oxide or indium zinc oxide. The electrode layer 16 is located between the color filter layer 14 and the liquid crystal layer 12. In the present embodiment, the electrode layer 16 completely covers the color filter layer 14, though the invention is not limited thereto. An electric field can be produced between the electrode layer 16 and the device layer PX for controlling or driving the liquid crystal layer 12.

The device layer PX is disposed on the first substrate 10. In the present embodiment, the device layer PX is composed of a plurality of pixel structures P. The pixel structure P includes a scan line, a data line, a driving device, a pixel electrode and a passivation layer, etc. (not shown). Further, referring to FIG. 2 and FIG. 3, the first color sub-pixel R includes the pixel structure P and the first color filter pattern RF disposed corresponding to the pixel structure P; the third color sub-pixel B includes the pixel structure P and the second color filter pattern BF disposed corresponding to the pixel structure P; the second color sub-pixel G includes the pixel structure P and the third color filter pattern GF disposed corresponding to the pixel structure P; and the white sub-pixel W includes the pixel structure P and the white filter pattern WF disposed corresponding to the pixel structure P. Namely, in the present embodiment, the first color sub-pixel R, the third color sub-pixel B and the second color sub-pixel G are respectively a red sub-pixel, a blue sub-pixel and a green sub-pixel.

Then, referring to FIG. 4, the display panel 1200 includes a first substrate 20, a device layer PX2, a first organic material layer 22, an organic light-emitting layer 24, a second organic material layer 26 and an electrode layer 28. In detail, in the present embodiment, the display panel 1200 is an OLED display panel.

The first substrate 20 is, for example, a glass substrate or a plastic substrate. The device layer PX is disposed on the first substrate 20. In the present embodiment, the device layer PX2 is composed of a plurality of pixel structures P2. The pixel structure P2 includes a scan line, a data line, a driving device, a pixel electrode and a passivation layer, etc. (not shown).

The first organic material layer 22 is disposed on the first substrate 20, which is, for example, at least one of a hole injection layer (HIL) and a hole transport layer (HTL). The HIL and the HTL are, for example, formed through an evaporation method.

The organic light-emitting layer 24 is disposed on the first organic material layer 22. The organic light-emitting layer 24 includes a plurality of first color organic light-emitting patterns RR, a plurality of second color organic light-emitting patterns BB, a plurality of third color organic light-emitting patterns GG and a plurality of white organic light-emitting patterns WW. To be specific, in the present embodiment, the first color organic light-emitting patterns RR, the second color organic light-emitting patterns BB and the third color organic light-emitting patterns GG are respectively red organic light-emitting patterns, blue organic light-emitting patterns and green organic light-emitting patterns. However, the invention is not limited thereto. In other embodiments, the first color organic light-emitting patterns RR, the second color organic light-emitting patterns BB and the third color organic light-emitting patterns GG can be an arbitrary combination of organic light-emitting patterns of other colors. Moreover, the first color organic light-emitting patterns RR, the second color organic light-emitting patterns BB, the third color organic light-emitting patterns GG and the white organic light-emitting patterns WW can be respectively any organic light-emitting pattern known by those skilled in the art.

Further, referring to FIG. 2 and FIG. 4, the first color sub-pixel R includes the pixel structure P2 and the first color organic light-emitting pattern RR disposed corresponding to the pixel structure P2; the third color sub-pixel B includes the pixel structure P2 and the second color organic light-emitting pattern BB disposed corresponding to the pixel structure P2; the second color sub-pixel G includes the pixel structure P2 and the third color organic light-emitting pattern GG disposed corresponding to the pixel structure P2; and the white sub-pixel W includes the pixel structure P2 and the white organic light-emitting pattern WW disposed corresponding to the pixel structure P2. Namely, in the present embodiment, the first color sub-pixel R, the third color sub-pixel B and the second color sub-pixel G are respectively a red sub-pixel, a blue sub-pixel and a green sub-pixel.

The second organic material layer 26 is located on the organic light-emitting layer 24. The second organic material layer 26 can be at least one of an electron transport layer (ETL) and an electron injection layer (EIL). The ETL and the EIL are, for example, formed through an evaporation method.

The electrode layer 28 is located on the second organic material layer 26. A material of the electrode layer 28 includes a transparent metal oxide conductive material, which is, for example, indium tin oxide, indium zinc oxide, aluminium tin oxide, aluminium zinc oxide, indium germanium zinc oxide, or other suitable oxides, or a stacked layer of at least two of the above oxides. Moreover, if necessary, a polarizer or a cover plate, etc. can be formed on the electrode layer 28.

Referring again to FIG. 1, the image signal input unit 1400 in the display device 1000 is configured to receive an image signal. The sub-pixel rendering unit 1600 in the display device 1000 is configured to perform a sub-pixel rendering process to the image signal received by the image signal input unit 1400, so that the sub-pixels (i.e. the first color sub-pixels R, the third color sub-pixels B, the second color sub-pixels G and the white color sub-pixels W) of the display panel 1200 produce a performance value. In detail, a method for performing the sub-pixel rendering process to the image signal includes following steps, in which the first color sub-pixels R are taken as an example for description. First, a sampling position analysis step is performed to define sampling ranges of the first color sub-pixels R in the first sub-units U1 and the second sub-units U2, where each of the sampling ranges is within a region including one first color sub-pixel R and other sub-pixels located adjacent to the first color sub-pixel R. Then, the sub-pixel rendering unit 1600 performs a sub-pixel rendering processing step of the first sub-unit and a sub-pixel rendering processing step of the second sub-unit to obtain transformation matrices corresponding to the aforementioned sampling ranges, and transforms the image signal of original pixel arrangement corresponding to the first color sub-pixels R in the first sub-units U1 or the second sub-units U2 into the image signal of new pixel arrangement according to the obtained corresponding transform matrices. Then, an mixing arrangement of image data processing step is executed to perform mixing arrangement on the image signals of new pixel arrangement of all of the first color sub-pixels R, i.e. to perform mixing arrangement on the image signal of new pixel arrangement corresponding to the first color sub-pixels R in the first sub-units U1 and the image signal of new pixel arrangement corresponding to the first color sub-pixels R in the second sub-units U2 that are obtained through transformation, so as to obtain the new pixel arrangement image signal corresponding to the first color sub-pixels R in the display panel 1200. Namely, through the transformation by the transformation matrix, the display panel 1200 generates different performance values after the sub-pixel rendering process.

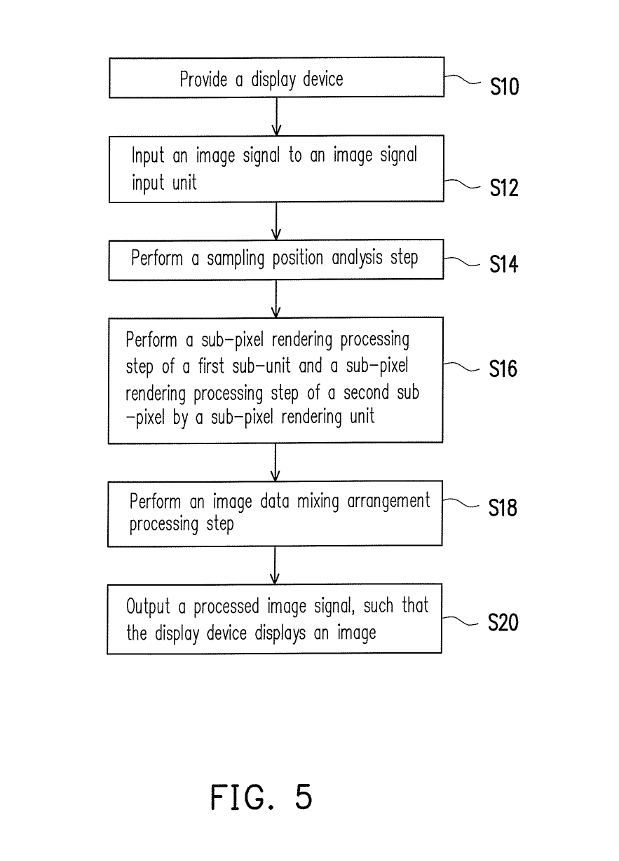

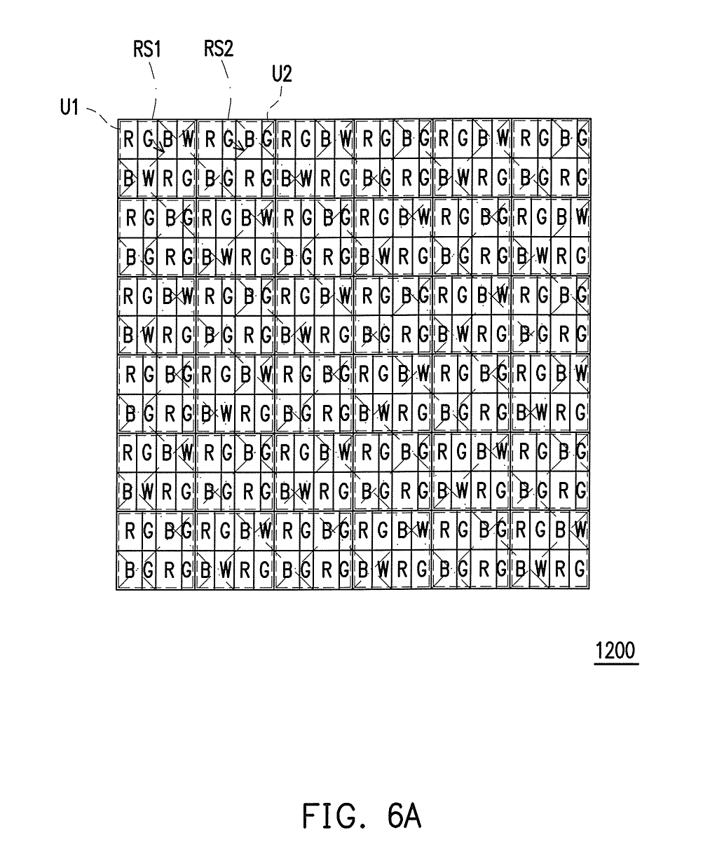

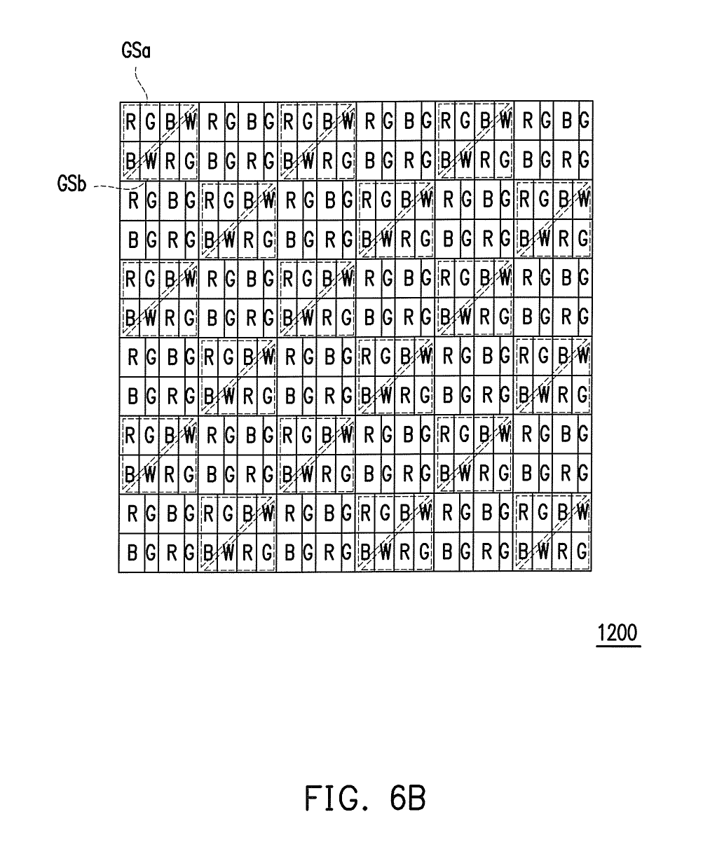

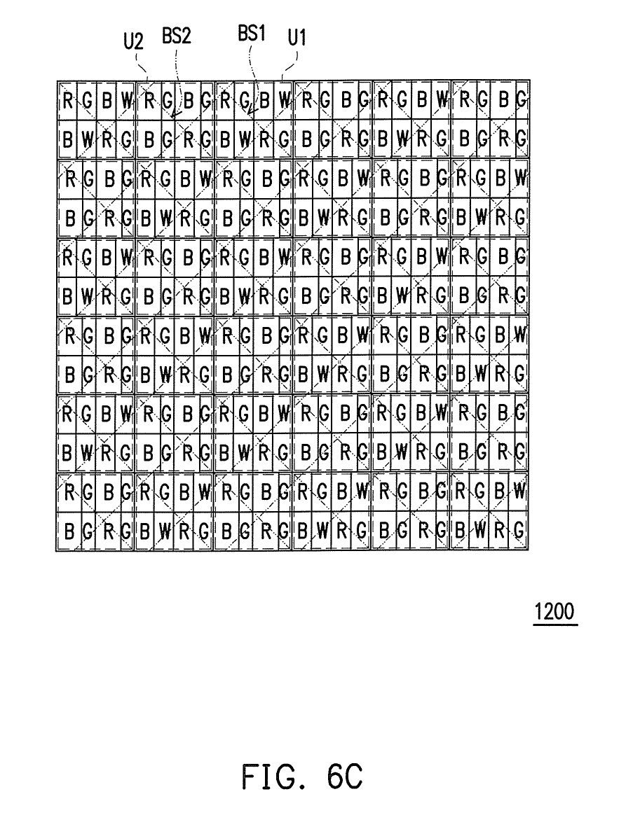

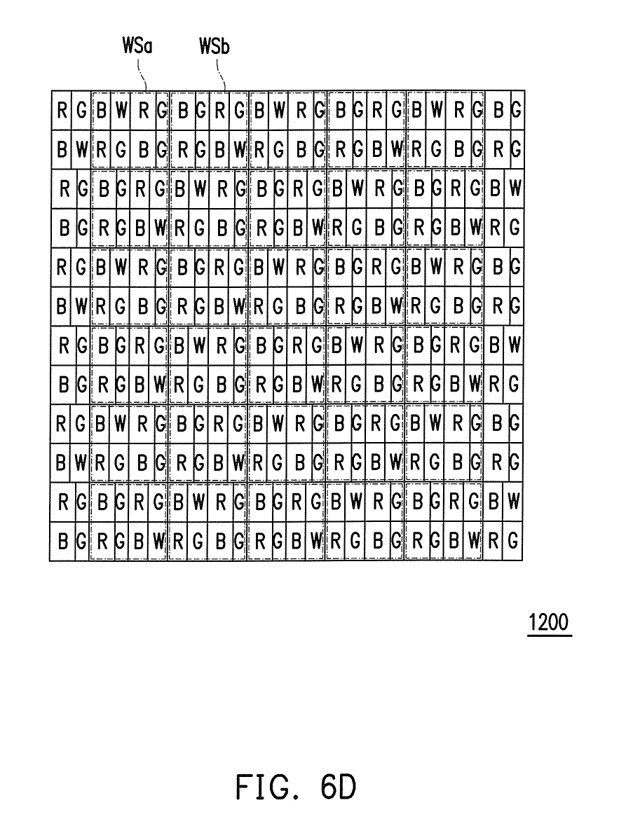

Moreover, in the present embodiment, the aforementioned performance value is brightness, though the invention is not limited thereto. In other embodiments, the performance value can be hue, lightness, saturation or gray level. For example, the brightness can be greater than or equal to 0 nits, the hue can be 0-360 degrees, the lightness can be 0-100, the saturation can be greater than or equal to 0, and the gray level can be 0-255. In the following description, a driving method of the display device 1000 of the present embodiment is described in detail with reference of FIG. 5, FIG. 6A to FIG. 6D. FIG. 5 is a flowchart illustrating a driving method of a display device according to an embodiment of the invention. FIG. 6A-FIG. 6D are respectively schematic views of defining a sampling range of a display panel of the display device of FIG. 1.

Referring to FIG. 5, first, in step S10, the display device 1000 is provided. Then, in step S12, image signals of original pixel arrangement respectively corresponding to the first color sub-pixels R, the second color sub-pixel G, the third color sub-pixel B and the white sub-pixel W in the first sub-units U1 and the second sub-units U2 are input to the image signal input unit 1400, i.e. the image signal input unit 1400 receives image signals with a specific performance value from the display panel 1200.

Then, in step S14, the sub-pixel rendering unit 1600 defines sampling ranges RS1 of the first color sub-pixels R in the first sub-units U1 and sampling ranges RS2 of the first color sub-pixels R in the second sub-units U2, as shown in FIG. 6A. In detail, the sampling ranges RS1 and the sampling ranges RS2 are adjacent to each other, and have the same area and shape. Then, in step S16, the sub-pixel rendering unit 1600 obtains transformation matrices corresponding to the sampling ranges RS1 and the sampling ranges RS2, and transforms the image signal of original pixel arrangement corresponding to the first color sub-pixels R in the first sub-units U1 or the second sub-units U2 into the image signal of new pixel arrangement according to the obtained corresponding transformation matrices. In detail, the transformation matrices corresponding to each sampling range RS1 and each sampling range RS2 respectively both are the following transformation matrix Matrix_R with a dimension of 3×3:

$$Matrix\_R = ( \begin{matrix}0 & 0.125 & 0 \\ 0.125 & 0.5 & 0.125 \\ 0 & 0.125 & 0\end{matrix} ) .$$

Moreover, a method for transforming the image signal of original pixel arrangement corresponding to the first color sub-pixels R in the first sub-units U1 or the second sub-units U2 into the image signal of new pixel arrangement according to the corresponding transformation matrices includes following steps. The values of the image signal of original pixel arrangement corresponding to the first color sub-pixels R in the first sub-units U1 and the values of the image signal of original pixel arrangement corresponding to the first color sub-pixels R in the second sub-units U2 are respectively multiplied by corresponding weight values, and, for each first color sub-pixel R, the multiplying results thereof are summed, so that the corresponding image signals of new pixel arrangement are obtained. In this way, one first color sub-pixel R in each sampling range RS1 or each sampling range RS2 provides a function the same as that provided by two R sub-pixels within a corresponding range in a conventional RGB display panel. Namely, compared with the conventional RGB display panel, the display panel 1200 can display the red color (i.e. a pure color) at the same level of brightness.

Then, the steps S14-S16 are repeated to perform the sampling position analysis step, the sub-pixel rending processing step of the first sub-unit and the sub-pixel rendering processing step of the second sub-pixel on the second color sub-pixel G, the third color sub-pixel B and the white sub-pixel W, respectively, and details thereof are introduced below with reference of FIG. 6B to FIG. 6D.

Referring to FIG. 6B, the second color sub-pixels G in each first sub-unit U1 have two sampling ranges GSa and GSb, which are adjacent to each other and have a same area and shape. In detail, the transform matrices corresponding to each sampling range GSa and each sampling range GSb are respectively the transform matrix Matrix_Ga and the transform matrix Matrix_Gb with a dimension of 2×2 show as follows:

$$Matrix\_Ga = ( \begin{matrix}0.5 & 0.25 \\ 0.25 & 0\end{matrix} )$$

$$Matrix\_Gb = ( \begin{matrix}0 & 0.25 \\ 0.25 & 0.5\end{matrix} ) .$$

Moreover, after the transformation performed through the aforementioned transformation matrices, one second color sub-pixel G in each of the sampling ranges GSa or the sampling ranges GSb provides a function the same as that provided by two sub-pixels R within a corresponding range in the conventional RGB display panel. It should be noted that in the second sub-unit U2, since each pixel has the second color sub-pixel G that is the same with the G sub-pixel in the conventional RGB display panel, the sub-pixel rendering unit 1600 does not perform the sub-pixel rendering process to the second sub-unit U2. In this way, compared to the conventional RGB display panel, the display panel 1200 can display the green color (i.e. a pure color) at the same level of brightness.

Moreover, referring to FIG. 6C, sampling ranges BS1 of the third color sub-pixels B in the first sub-units U1 and sampling ranges BS2 of the third color sub-pixels B in the second sub-units U2 are adjacent to each other and have a same area and shape. In detail, the transformation matrices corresponding to each sampling range BS1 and each sampling range BS2 respectively both are the following transformation matrix Matrix B with a dimension of 3×3:

$$Matrix\_B = ( \begin{matrix}0 & 0.125 & 0 \\ 0.125 & 0.5 & 0.125 \\ 0 & 0.125 & 0\end{matrix} ) .$$

Moreover, after the transformation performed through the aforementioned transformation matrices, one third color sub-pixel B in each sampling range BSa or each sampling range BSb provides a function the same as that provided by two B sub-pixels within a corresponding range in the conventional RGB display panel. In this way, compared to the conventional RGB display panel, the display panel 1200 can display the blue color (i.e. a pure color) at the same level of brightness.

Moreover, referring to FIG. 6D, the white sub-pixels W in each first sub-unit U1 have two sampling ranges WSa and WSb. Each of the sampling ranges WSa and WSb includes ½ first sub-unit U1 and ½ second sub-unit U2, i.e. each of the sampling ranges WSa and WSb includes eight complete sub-pixels, and the eight sub-pixels include one first color sub-pixel R, one second color sub-pixel G, one third color sub-pixel B and one white sub-pixel W in the first sub-unit U1, and one first color sub-pixel R, two second color sub-pixels G and one third color sub-pixel B in the second sub-unit U2. In detail, the transformation matrices corresponding to each sampling range WSa and each sampling range WSb are respectively the transform matrix Matrix_Wa and the transform matrix Matrix_Wb with a dimension of 2×2 show as follows:

$$Matrix\_Wa = ( \begin{matrix}0.5 & 0.2 \\ 0.2 & 0.1\end{matrix} )$$

$$Matrix\_Wb = ( \begin{matrix}0.1 & 0.2 \\ 0.2 & 0.5\end{matrix} ) .$$

Moreover, after the transformation performed through the aforementioned transformation matrices, one white sub-pixel W in each sampling range WSa or each sampling range WSb provides a brightness larger than that provided by the conventional RGB display panel.

Then, referring to FIG. 5 again, in step S18, a mixing arrangement is performed to the image signal of new pixel arrangement corresponding to the first color sub-pixels R in the first sub-units U1 and the image signal of new pixel arrangement corresponding to the first color sub-pixels R in the second sub-units U2 to obtain the image signal of new pixel arrangement corresponding to the first color sub-pixels R in the display panel 1200; the mixing arrangement is performed to the two image signals of new pixel arrangement corresponding to the second color sub-pixels G in the first sub-units U1 and the image signal of original pixel arrangement corresponding to the second color sub-pixels G in the second sub-units U2 to obtain the image signal of new pixel arrangement corresponding to the second color sub-pixels G in the display panel 1200; the mixing arrangement is performed to the image signal of new pixel arrangement corresponding to the third color sub-pixels B in the first sub-units U1 and the image signal of new pixel arrangement corresponding to the third color sub-pixels B in the second sub-units U2 to obtain the image signal of new pixel arrangement corresponding to the third color sub-pixels B in the display panel 1200; and the mixing arrangement is performed to the two image signals of new pixel arrangement corresponding to the white sub-pixels W in the first sub-units U1 to obtain the image signal of new pixel arrangement corresponding to the white sub-pixels W in the display panel 1200.

Finally, in a step S20, the image signals of new pixel arrangement corresponding to the first color sub-pixels R, the second color sub-pixels G, the third color sub-pixels B and the white sub-pixels W in the display panel 1200 are combined to form a processed image signal (i.e. a full color image signal), and the processed image signal is output to make the display panel 1200 to display an image.

It should be noted that in the present embodiment, the pixels in the first sub-unit U1 and the second sub-unit U2 are all composed of 2 sub-pixels, and an area thereof is the same with the area of the pixel (i.e. 3 sub-pixels) in the conventional RGB display panel. In other words, in the present embodiment, the area of each first color sub-pixel R, each second color sub-pixel G, each third color sub-pixel B or each white sub-pixel W in the display panel 1200 is either equal to or greater than the area of each R sub-pixel, each G sub-pixel or each B sub-pixel in the conventional RGB display panel, such that the number of metal wires configured in the display panel 1200 is decreased. In this way, in the display device 1000, the display panel 1200 is used in collaboration with the image signal input unit 1400 and the sub-pixel rendering unit 1600 to perform the sub-pixel rendering process, by which not only a pixel aperture ratio is enhanced to achieve good transmittance and brightness, but also good image quality is provided. On the other hand, in the present embodiment, by adding the white sub-pixels W to the display panel 1200, the transmittance and a none pure-color (i.e. white color) brightness of the display panel 1200 are increased compared with that of the conventional RGB display panel.

Moreover, as described above, since compared with the RGBW sub-pixels in the conventional RGBW display panel, in the display panel 1200 each first color sub-pixel R, each second color sub-pixel G or each third color sub-pixels B has a larger area, and since the total area of the first color sub-pixels R, the total area of the second color sub-pixels G and the total area of the third color sub-pixels B in the display panel 1200 are the same and are greater than the total area of the white sub-pixels W, in the display device 1000, by using the image signal input unit 1400 and the sub-pixel rendering unit 1600 to perform the sub-pixel rendering process, the display panel 1200 can resolve the problem of the conventional RGBW display panel that a pure-color (i.e. the red color, the green color, the blue color) brightness is excessively low and a none pure-color (i.e. the white color) brightness is excessively high, and has a good pure-color and none pure-color brightness, so as to provide images with good quality.

Moreover, in the embodiment of FIG. 2, the two first sub-units U1 of different rows in the repeating unit 100 are arranged in interleaving, and the two second sub-units U2 of different rows are arranged in interleaving. However, the invention is not limited thereto, and it is considered to be within the scope of the invention as long as the repeating unit includes two first sub-units U1 and two second sub-units U2.

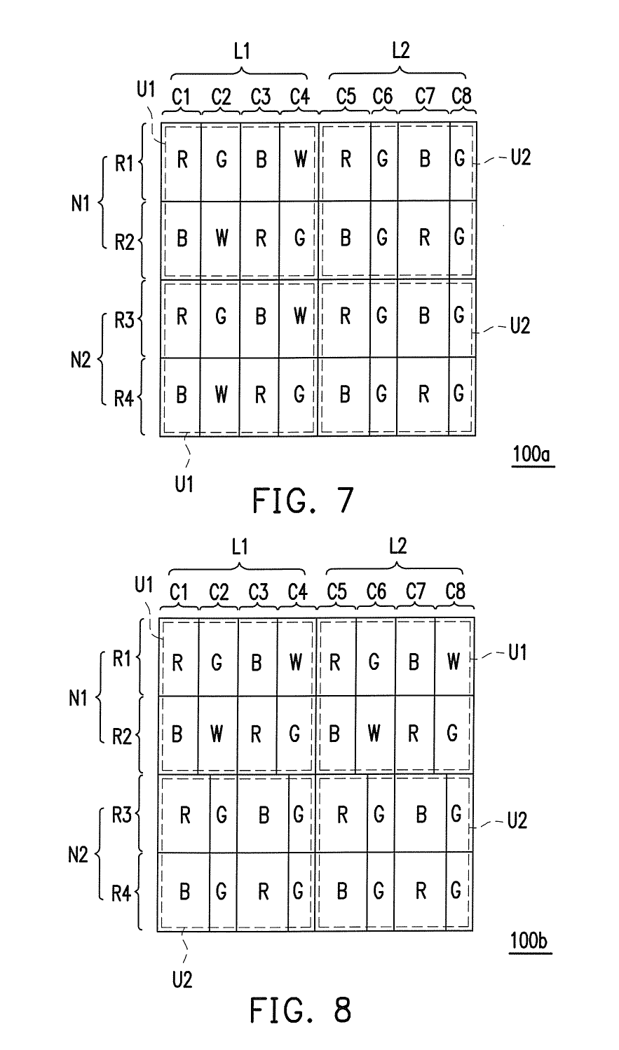

FIG. 7 is a schematic top view of a second embodiment of the repeating unit of the invention. FIG. 8 is a schematic top view of a third embodiment of the repeating unit of the invention. For clarity's sake, the scan lines SL1-SL4, the data lines DL1-DL8 and the driving devices T are omitted in FIG. 7 and FIG. 8. Moreover, the repeating unit 100a and the repeating unit 100b shown in FIG. 7 and FIG. 8 are similar to the repeating unit 100 of FIG. 2, so that the same or similar components are denoted by the same or similar referential numbers, and details thereof are not repeated.

In detail, referring to FIG. 7, FIG. 8 and FIG. 2, a difference between the repeating units 100a and 100b shown in FIG. 7 and FIG. 8 and the repeating unit 100 of FIG. 2 is only that configurations of the first sub-units U1 and the second sub-units U2 are different. In following description, sub-pixel configurations of the repeating units 100a and 100b are described with reference of FIG. 7 and FIG. 8.

Referring to FIG. 7, in the repeating unit 100a, the two first sub-units U1 are all on the column L1, and the two second sub-units U2 are all on the column L2. In detail, in the repeating unit 100a, the row R1 includes, from left to right, the first color sub-pixel R, the second color sub-pixel G, the third color sub-pixel B, the white sub-pixel W, the first color sub-pixel R, the second color sub-pixel G, the third color sub-pixel B and the second color sub-pixel G; the row R2 includes, from left to right, the third color sub-pixel B, the white sub-pixel W, the first color sub-pixel R, the second color sub-pixel G, the third color sub-pixel B, the second color sub-pixel G, the first color sub-pixel R and the second color sub-pixel G; the row R3 includes, from left to right, the first color sub-pixel R, the second color sub-pixel G, the third color sub-pixel B, the white sub-pixel W, the first color sub-pixel R, the second color sub-pixel G, the third color sub-pixel B and the second color sub-pixel G; and the row R4 includes, from left to right, the third color sub-pixel B, the white sub-pixel W, the first color sub-pixel R, the second color sub-pixel G, the third color sub-pixel B, the second color sub-pixel G, the first color sub-pixel R and the second color sub-pixel G (arrangement 5).

Then, referring to FIG. 8, in the repeating unit 100b, the two first sub-units U1 are all on the row N1, and the two second sub-units U2 are all on the row N2. In detail, in the repeating unit 100b, the row R1 includes, from left to right, the first color sub-pixel R, the second color sub-pixel G, the third color sub-pixel B, the white sub-pixel W, the first color sub-pixel R, the second color sub-pixel G, the third color sub-pixel B and the white sub-pixel W; the row R2 includes, from left to right, the third color sub-pixel B, the white sub-pixel W, the first color sub-pixel R, the second color sub-pixel G, the third color sub-pixel B, the white sub-pixel W, the first color sub-pixel R and the second color sub-pixel G; the row R3 includes, from left to right, the first color sub-pixel R, the second color sub-pixel G, the third color sub-pixel B, the second color sub-pixel G, the first color sub-pixel R, the second color sub-pixel G, the third color sub-pixel B and the second color sub-pixel G; and the row R4 includes, from left to right, the third color sub-pixel B, the second color sub-pixel G, the first color sub-pixel R, the second color sub-pixel G, the third color sub-pixel B, the second color sub-pixel G, the first color sub-pixel R and the second color sub-pixel G (arrangement 6).

It should be noted that since the difference between the repeating units 100a-100b and the repeating unit 100 only lies in different configurations of the first sub-units U1 and the second sub-units U2, according to the descriptions related to FIG. 1, FIG. 5 and FIG. 6A-FIG. 6D, those skilled in the art should understand that a driving method of the display panel having the repeating units 100a-100b, and even the sub-pixel rending process method.

Moreover, as described above, the area of each first color sub-pixel R, each second color sub-pixel G, each third color sub-pixel B or each white sub-pixel W in the display panels having the repeating units 100a and 100b is either equal to or greater than the area of each R sub-pixel, each G sub-pixel or each B sub-pixel in the conventional RGG display panel, such that the number of metal wires configured in the display panel is decreased. In this way, after the sub-pixel rendering process is performed, not only the pixel aperture ratios of the display panels are enhanced to have good transmittance and brightness, but also good image quality is provided.

Moreover, by adding the white sub-pixels W to the display panels having the repeating units 100a and 100b, the transmittance and the none pure-color (i.e. white color) brightness of the display panels are increased compared with that of the conventional RGB display panel. In addition, as in the display panels having the repeating units 100a and 100b each first color sub-pixel R, each second color sub-pixel G or each third color sub-pixel B has a larger area, the total area of the first color sub-pixels R, the total area of the second color sub-pixels G and the total area of the third color sub-pixels B are equal to each other and are greater than the total area of the white sub-pixels W, and by performing the sub-pixel rendering process on the display panels, the display panels can resolve the problem of the conventional RGBW display panel that a pure-color (i.e. the red color, the green color, the blue color) brightness is excessively low and a none pure-color (i.e. the white color) brightness is excessively high, and have a good pure-color and none pure-color brightness, so as to provide images with good quality.

It should be noted that besides that the display device 100 of FIG. 1 and the display devices having the repeating units 100a and 100b have good pixel aperture ratios, transmittances, pure-color brightness and none pure-color brightness, by performing the sub-pixel rendering process, a good image visual resolution is also achieved. In this way, the display device of the invention can be applied to a head-up display.

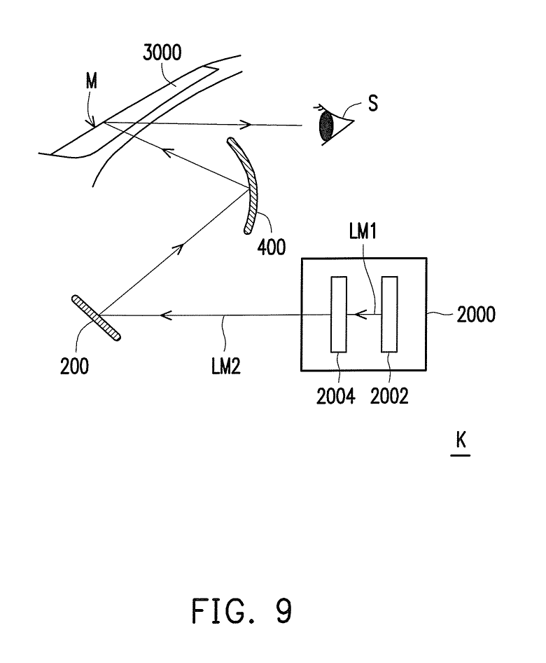

FIG. 9 is a schematic view of a head-up display according to an embodiment of the invention. Referring to FIG. 9, the head-up display K is configured below a light transmissive windshield 3000 of a vehicle. In the present embodiment, the vehicle is, for example, a car, and the light transmissive windshield 3000 is, for example, a glass windshield in front of a driver. However, the invention is not limited thereto. In other embodiments, the vehicle can also be a train, an airplane, a ship, a submarine or any other type of vehicle, and the light transmissive windshield 3000 can be a window located beside a passenger aboard the vehicle or a transparent screen configured at other location.

In detail, the head-up display K includes a display module 2000. The display module 2000 includes a light-emitting device 2002 and a display device 2004. In the present embodiment, an illumination beam LM1 emitted by the light-emitting device 2002 may pass through the display device 2004 and may then be converted into an image beam LM2. The image beam LM2 may be projected onto the light transmissive windshield 3000 of the vehicle to generate an image M for a user S to watch.

Moreover, the head-up display K may selectively include an optical element 200 disposed on a transmission path of the image beam LM2. In the present embodiment, the optical element 200 is, for example, a planar reflective mirror. In detail, the optical element 200 may change the transmission direction of the image beam LM2 for transmitting the image beam LM2 to the light transmissive windshield 3000 to produce the image. In addition, the head-up display K further may selectively include an optical element 400 disposed on a transmission path of the image beam LM2 coming from the optical element 200. In the present embodiment, the optical element 400 is, for example, a curved reflective mirror. In detail, the optical element 400 not only can again change the transmission direction of the image beam LM2, extend the transmission path of the image beam LM2, and accordingly increase the dimension of the image M, but also can compensate the aberration of the image M generated on the curved light transmissive windshield 3000, such that the user S is allowed to watch the image with good image quality. However, the head-up display is not limited thereto. In other embodiments, the head-up display may adopt a plurality of optical elements according to an actual design requirement. For example, the head-up display may adopt three reflective optical elements or two reflective optical element plus one lens element to construct the optical path of the head-up display.

Moreover, in the present embodiment, the display device 2004 can be implemented by the display device 1000 of FIG. 1 or the display device having the repeating unit 100a or 100b. Further, in the present embodiment, the display device 2004 is implemented by the display device 1000 in which the display panel 1200 is a none self-luminous display panel (as shown in FIG. 3) or implemented by the display device having the repeating unit 100a or 100b in which the display panel is the none self-luminous display panel. In this way, the display device 2004 has a good transmittance, and accordingly can display the image M with good brightness (and even good pure-color brightness) and good display quality. Moreover, since the transmittance of the display device 2004 is enhanced, power consumption of a backlight plate thereof is saved, so as to decrease an overall power consumption of the head-up display K.

Moreover, although a situation that the display module 2000 of the head-up display K includes the light-emitting device 2002 and the display device 2004 is taken as an example for description, the invention is not limited thereto. In other embodiments, the display module of the head-up display may only include a display device. In this case, the display device can be implemented by the display device 1000 in which the display panel 1200 thereof is a self-luminous display panel (as shown in FIG. 4) or implemented by the display device having the repeating unit 100a or 100b in which the display panel is the self-luminous display panel.

In summary, in the display device of the invention, each of the repeating units in the display panel includes two first sub-units and two second sub-units, wherein each of the first sub-units includes two first color sub-pixels, two second color sub-pixels, two third color sub-pixels and two white sub-pixels, and each of the second sub-units includes two first color sub-pixels, four second color sub-pixels and two third color sub-pixels. The display panel is used in collaboration with the image signal input unit and the sub-pixel rendering unit to perform the sub-pixel rendering process. In this way, compared with the conventional display device, the display device of the invention has a good pixel aperture ratio, transmittance, pure-color and none pure-color brightness and image visual resolution, so as to provide good image quality.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A display device, comprising:
a display panel, comprising a plurality of repeating units, and each of the repeating units comprising:
two first sub-units, wherein each of the first sub-units comprises eight sub-pixels, and the eight sub-pixels comprise two first color sub-pixels, two second color sub-pixels, two third color sub-pixels and two white sub-pixels; and
two second sub-units, wherein each of the second sub-units comprises eight sub-pixels, and the eight sub-pixels comprise two first color sub-pixels, four second color sub-pixels and two third color sub-pixels;
an image signal input unit, configured to receive an image signal; and
a sub-pixel rendering unit, configured to perform a sub-pixel rendering process to the image signal, so that the sub-pixels of the display panel produce a performance value.

2. The display device as claimed in claim 1, wherein eight of the sub-pixels of the first sub-unit are arranged in an array of two rows and four columns (2×4).

3. The display device as claimed in claim 1, wherein a first row and a second row of the first sub-unit respectively have one first color sub-pixel, one second color sub-pixel, one third color sub-pixel and one white sub-pixel.

4. The display device as claimed in claim 2, wherein in the first sub-unit, an arrangement of four sub-pixels of a first row is different to an arrangement of four sub-pixels of a second row.

5. The display device as claimed in claim 2, wherein an arrangement of eight of the sub-pixels of the first sub-unit is:
R G B W
B W R G
wherein R is the first color sub-pixel, G is the second color sub-pixel, B is the third color sub-pixel and W is the white color sub-pixel.

6. The display device as claimed in claim 2, wherein areas of eight of the sub-pixels of the first sub-unit are the same.

7. The display device as claimed in claim 1, wherein eight of the sub-pixels of the second sub-unit are arranged in an array of two rows and four columns (2×4).

8. The display device as claimed in claim 7, wherein a first row and a second row of the second sub-unit respectively have one first color sub-pixel, two second color sub-pixels and one third color sub-pixel.

9. The display device as claimed in claim 7, wherein in the second sub-unit, an arrangement of four sub-pixels of a first row is different to an arrangement of four sub-pixels of a second row.

10. The display device as claimed in claim 7, wherein an arrangement of eight of the sub-pixels of the second sub-unit is:
R G B G
B G R G
wherein R is the first color sub-pixel, G is the second color sub-pixel and B is the third color sub-pixel.

11. The display device as claimed in claim 7, wherein in the second sub-unit, an area of each of the second color sub-pixels is 50% of an area of one first color sub-pixel, and the area of the first color sub-pixel is the same with an area of the third color sub-pixel.

12. The display device as claimed in claim 1, wherein two of the first sub-units and two of the second sub-units are arranged in an array of two rows and two columns (2×2).

13. The display device as claimed in claim 1, wherein an arrangement of two of the first sub-units and two of the second sub-units is one of following arrangements:
U1 U2
U2 U1 (arrangement 1)
U1 U2
U1 U2 (arrangement 2)
U1 U1
U2 U2 (arrangement 3)
wherein U1 is the first sub-unit and U2 is the second sub-unit.

14. The display device as claimed in claim 1, wherein an arrangement of thirty-two sub-pixels of the repeating unit is one of following arrangements:
R G B W R G B G
B W R G B G R G
R G B G R G B W
B G R G B W R G (arrangement 4)
R G B W R G B G
B W R G B G R G
R G B W R G B G
B W R G B G R G (arrangement 5)
R G B W R G B W
B W R G B W R G
R G B G R G B G
B G R G B G R G (arrangement 6).

15. A driving method of a display device, comprising:
providing the display device as claimed in claim 1;
inputting the image signal to the image signal input unit;
performing a sampling position analysis step;
performing a sub-pixel rendering processing step of a first sub-unit and a sub-pixel rendering processing step of a second sub-pixel by the sub-pixel rendering unit;
performing an mixing arrangement of image data processing step; and
outputting a processed image signal, such that the display device displays an image.

16. The driving method of the display device as claimed in claim 15, wherein an arrangement of two of the first sub-units and two of the second sub-units of the display device is one of following arrangements:
U1 U2
U2 U1 (arrangement 1)
U1 U2
U1 U2 (arrangement 2)
U1 U1
U2 U2 (arrangement 3)
wherein U1 is the first sub-unit and U2 is the second sub-unit.

17. The driving method of the display device as claimed in claim 16, wherein an arrangement of thirty-two sub-pixels of the repeating unit is one of following arrangements:
R G B W R G B G
B W R G B G R G
R G B G R G B W
B G R G B W R G (arrangement 4)
R G B W R G B G
B W R G B G R G
R G B W R G B G
B W R G B G R G (arrangement 5)
R G B W R G B W
B W R G B W R G
R G B G R G B G
B G R G B G R G (arrangement 6).
